(19) United States
(12) Patent Application Publication
(10) Pub. No.: US 2018/0025292 A1
(43) Pub. Date: Jan. 25, 2018

(54) SYSTEMS AND METHODS FOR OPTIMIZING TRAVEL BOOKINGS

(71) Applicant: MasterCard International Incorporated, Purchase, NY (US)

(72) Inventors: David J. Senci, Troy, IL (US); Peng Yang, Chesterfield, MO (US)

(21) Appl. No.: 15/214,128

(22) Filed: Jul. 19, 2016

(51) Int. Cl. G06Q 10/02

(52) U.S. Cl. CPC G06Q 10/02

(57) ABSTRACT

Systems and methods for optimizing travel bookings. A travel analyzing computing device is configured to retrieve historic transaction data including addendum data from travel booking transactions of cardholders. The travel analyzing computing device then extracts booking information comprising booking dates, travel dates, and prices from the retrieved historic transaction data. The travel analyzing computing device is further configured to receive booking inquiries comprising a travel date. Based on the travel date indicated in the booking inquiry, the travel analyzing computing device generates booking data including an optimal booking date. The travel analyzing computing device may then transmit the booking data, including the optimal booking date, to the user computing device.

### BACKGROUND

The present application relates generally to determining and making optimal travel bookings. More particularly, this application relates to a network-based system and method for determining optimal travel bookings based on booking information collected from previous travel-based transactions of cardholders.

The price of travel bookings is an important factor in planning a trip. However, the search for a deal on airline tickets, vehicle rentals, hotel rooms, and the like is often complicated by significant price variations. Cost-conscious travelers are often faced with the challenge of finding the best travel deal based not only on travel dates, but also booking dates (i.e., when a booking is made).

Although known travel-related websites and applications provide pricing information for travel bookings, the functionality of these tools is limited. Specifically, pricing information is provided under the assumption that a user intends to make a travel booking at the time of his or her inquiry. Doing so ignores the effect of booking date on price and, as a result, prevents users from taking advantage of lower prices that may be available by booking on a later date. Moreover, there is a disincentive for travel-related websites and applications to present their users with travel prices that are based on booking dates because doing so may discourage users from making immediate purchases. Ultimately, a traveler trying to determine the best travel deal for a given trip may be required to run multiple searches on multiple days using multiple travel websites or applications.

Accordingly, a system and method is needed that enables a user to take advantage of prior booking data to optimize travel bookings.

### BRIEF DESCRIPTION OF THE DISCLOSURE

In one aspect, a travel analyzing computing device for optimizing travel bookings is provided. The travel analyzing computing device includes one or more processors in communication with one or more memory devices, and is configured to: retrieve historical transaction data including addendum data from travel booking transactions of cardholders; extract, from the retrieved historic transaction data, historic booking information comprising booking dates, travel dates, and prices; receive, from a user computing device, a booking inquiry comprising booking criteria, the booking criteria further comprising a travel date; generate, based on at least the historic booking information and the travel date, booking data wherein the booking data includes an optimal booking date corresponding to the booking inquiry; and transmit the booking data to the user computing device.

In another aspect, a computer-implemented method for optimizing travel bookings is provided. The method is implemented by a travel booking information computing device and includes: retrieving historic transaction data including addendum data from travel booking transactions of cardholders; extracting, from the retrieved historic transaction data, historic booking information comprising booking dates, travel dates, and prices; receiving, from a user computing device, a booking inquiry comprising booking criteria, the booking criteria further comprising a travel date; generating, based on at least the historic booking information and the travel date, booking data wherein the booking data includes an optimal booking date corresponding to the booking inquiry; and transmitting the booking data to the user computing device.

In another aspect, a non-transitory computer-readable storage media having computer-executable instructions embodied thereon is provided. When executed by at least one processor, the computer-executable instructions cause the at least one processor to: retrieve historic transaction data including addendum data from travel booking transactions of cardholders; extract, from the retrieved historic transaction data, historic booking information comprising booking dates, travel dates, and prices; receive, from a user computing device, a booking inquiry comprising booking criteria, the booking criteria further comprising a travel date; generate, based on at least the booking information and the travel date, booking data wherein the booking data includes an optimal booking date corresponding to the booking inquiry; and transmit the booking data to the user computing device.

### BRIEF DESCRIPTION OF THE DRAWINGS

FIG. 1 is a schematic diagram illustrating an example of a multi-party payment processing system for processing payment card transactions.

FIG. 2 is a diagram illustrating a travel analyzing system including a travel analyzing computing device, in communication with the payment processing system in accordance with an example embodiment of the present disclosure.

FIG. 3 is a diagram illustrating an example of a travel analyzing computing device as shown in FIG. 2.

FIG. 4 is a diagram illustrating an example of a user computing device that may be used by a user, such as the cardholder as shown in FIG. 2.

FIG. 5 is a diagram illustrating an example of a method of a travel analyzing computing device providing booking data to a user, in accordance with an example embodiment of the present disclosure.

FIG. 6 is a depiction of a user interface for determining and inputting a preferred travel date.

FIG. 7 is a depiction of a user interface for determining and inputting a preferred booking date.

### DETAILED DESCRIPTION OF THE DISCLOSURE

For the average traveler, price is one of the most significant factors in determining whether to make a travel booking. However, accurately predicting travel booking prices is a complicated task because they often vary significantly depending on travel dates (i.e., the dates associated with a particular booking, such as flight departure and arrival dates) and booking dates (i.e., the dates on which bookings for particular travel dates are made). For example, the price for the same flight will often change depending on whether tickets are purchased two or six weeks in advance. Given the complexity of travel booking pricing, the general rules of thumb applied by many travelers often fall short in helping travelers determine optimal bookings.

Here, a booking is generally used to refer to any travel-related arrangement made or reserved in advance and may include a plane ticket, a rental car, a hotel booking, and the like. A traveler may make any number of bookings in preparation for or while traveling. As described herein, travel may refer to business travel, a vacation, personal travel, corporate travel, and the like.

For purposes of this disclosure, an optimal booking date is a booking date having the lowest price for particular travel dates. Optimal travel dates, on the other hand, refer to travel dates having the lowest price while still meeting a traveler's booking criteria. For example, if a traveler specifies that he or she would like to book a four-star hotel for three days, less expensive three-star hotels will not be considered in determining optimal travel dates. Accordingly, based on a combination of optimal booking date and optimal travel dates, an optimal booking is a booking that meets a traveler's particular booking criteria at the lowest price.

For purposes of this disclosure, a lowest price may be the absolute lowest price associated with the particular travel dates. However, in some instances, the lowest prices for a particular travel dates may have been the result of a special discount, promotion, or use of rewards or travel points. Accordingly, in some embodiments, determining the lowest price for particular travel dates may exclude such reduced pricing.

Reduced pricing may be identified in various ways. For example, in certain embodiments, a price for a booking may be compared to a historical average for the booking. As another example, a price for a booking may also be compared to a threshold value independent of a historical average. As third example, transaction data associated with a booking may include data indicating a promotion, a discount, use of travel rewards or points, or any other basis for a reduced price.

When planning a trip, travelers often rely on a variety of known travel sites and applications to research and make travel bookings. However, known travel sites are limited in their abilities to determine optimal bookings. Specifically, known travel sites operate under the mistaken assumption that a user is interested only in booking travel arrangements immediately. Doing so ignores the significant effect of booking date on booking prices, and, as a result, prevents users from efficiently determining an optimal booking.

In light of the above limitations of known travel sites and applications, a system that permits a traveler to account for both travel dates and booking dates is desirable as it would allow a traveler to achieve the best price for a particular travel arrangement. As disclosed herein, an approach to resolving this issue is to use a travel analyzing computing device, as described herein, to collect and analyze booking information extracted from the transaction data of previous travel-based transactions to determine or predict an optimal booking date.

In general, the transaction data received by the travel analyzing computing device originates from a transaction, such as a transaction associated with a debit card, credit card, loyalty card, rewards card, and the like, (collectively a “payment card”). During a transaction, transaction data, which may include data regarding the purchased items, the merchant from which the purchase was made, the cardholder, and the like, may be generated and stored by a financial entity or the payment processor. Financial entities may include banks, such as an issuer bank or an acquirer bank, and the like. The transaction data may then be collected and analyzed for various purposes including analyzing cardholder spending habits, authentication and other fraud protection measures, and the like.

The present disclosure provides examples of a travel analyzing computing device in communication with a financial entity or payment processor, or a memory associated with a financial entity or payment processor, that receives transaction data associated with travel bookings. For one or more of the transactions contained in the transaction data, the travel analyzing computing device may extract booking information, such as booking price, booking date, and travel dates associated with the booking. In response to a booking inquiry containing details of an intended trip, the travel analyzing computing device may provide historical data, predictions, or recommendations derived from the booking information that correspond to the booking inquiry. If a particular booking date is selected, the travel analyzing computing device may be further configured to provide alerts or reminders to book on the booking date or to automatically book travel arrangements. The alerts may be sent to a user device, which activates the user device from a “sleep mode” to an “active display mode” and causes the user device to display details regarding the booking associated so that a user can determine whether to make a booking.

The transaction data received and analyzed by the travel analyzing computing device may be generated throughout the transaction process. For example, a financial transaction typically includes an authorization process, a settlement process, and clearing process, during each of which transaction data may be collected and/or supplemented.

During authorization, for example, an initial payment amount is processed to determine whether the cardholder has sufficient funds to cover the initial payment amount. At this point, a financial entity or payment processor processing the transaction may receive transaction data including merchant name, purchase amount, and the like. This data is referred to as authorization data.

The transaction data collected during the authorization process may be further supplemented by additional data collected during the clearing process. An authorization for a transaction typically occurs immediately or within a few minutes of a purchase, however, a clearing process or “clearing” may take additional time, for example, until the end of a business day, 12-hours, 24-hours, 2 days, 3 days, and the like. During clearing, transaction data may be supplemented with additional data, generally referred to as addendum data, that includes additional details about a cardholder and about items purchased by the cardholder. For example, when a cardholder makes a purchase such as an airline ticket, authorization data of the purchased airline ticket may include the airline merchant name or ID, the amount of the purchase, the time of the purchase, and the like. The addendum data acquired during the clearing process may further include a departure location, a destination, type of ticket purchased (e.g., coach, first class, business class, etc.), flight itinerary, flight number, flight time, and the like.

While transaction data obtained during authorization may be relatively generic, addendum data may include details unique to the type of transaction. For example, in addition to purchases of airfare, other common types of travel bookings include reservations of rental cars and hotel rooms. For vehicle rental bookings, addendum data may include pickup and drop-off locations, miles driven, insurance type, a corporate flag, a tax exemption flag and a rental class. For hotel reservations, addendum data may include the number of nights stayed by the cardholder, the location of the hotel, the hotel's star rating, and amenities available at the hotel. Here, a hotel may refer to any type of lodging, for example, hotels, motels, bed and breakfasts, inns, and the like.

According to various examples herein, a travel analyzing computing device with access to the transaction data, for example, a travel analyzing computing device associated with or in communication with the payment processor, may analyze the transaction data and extract booking information from the transaction data. In response to a booking inquiry containing details of a planned travel arrangement, the travel analyzing computing device may use the historical booking information to determine the optimal booking date for the travel arrangements. For example, if a booking inquiry contains a flight for a particular day and time, the computing system may provide an optimal booking date corresponding to the date on which tickets meeting the flight and day/time criteria may be booked for the lowest price.

Booking data may be provided to a user by the travel analyzing computing device via a website, mobile application, or the like. The term booking data is generally used herein to refer to any information relevant to booking as determined by the travel analyzing computing device. Booking data may include transaction data, booking information, or any data derived from transaction data or booing information. The travel analyzing computing device may provide the booking data via an interactive website in response to a user submitting a booking inquiry. As another example, the travel analyzing computing device may be configured to communicate booking data to a user through an e-mail, regular mail, a phone call, and the like. The travel analyzing computing device may further be configured to provide an alert or reminder when the optimal booking date arrives, or may be configured to automatically complete the optimal booking at the appropriate time.

While determining optimal bookings benefits travelers by ensuring they are able to make travel arrangements at the best prices, the travel analyzing computing device also provides significant technical benefits regarding issues rooted in computer networking. For example, determining the optimal booking date may significantly reduce the amount of network traffic associated with booking a travel arrangement. With known travel sites and applications, travelers trying to determine an optimal booking date are usually required to run multiple searches across multiple days to determine changes and trends in booking prices. As a result, network traffic associated with a booking may be multiplied. Using an embodiment of the present disclosure, this traffic-heavy trial-and-error approach to determining an optimal booking date is eliminated. Network traffic may be further reduced in certain embodiments in which the travel analyzing computing device is configured to send alerts or notifications to a user for bookings in which the user has an interest. For example, an alert or notification may be sent to a user on the optimal booking date or may be sent to the user to alert or notify the user regarding changes in booking prices. Doing so eliminates the need for the user to frequently check booking prices. As a result, a traveler may be provided with all of the booking date and price information necessary for an informed purchasing decision and may establish an alert to notify the user of a change in booking date and price information in response to a single search.

Example of Payment Card Transaction Network

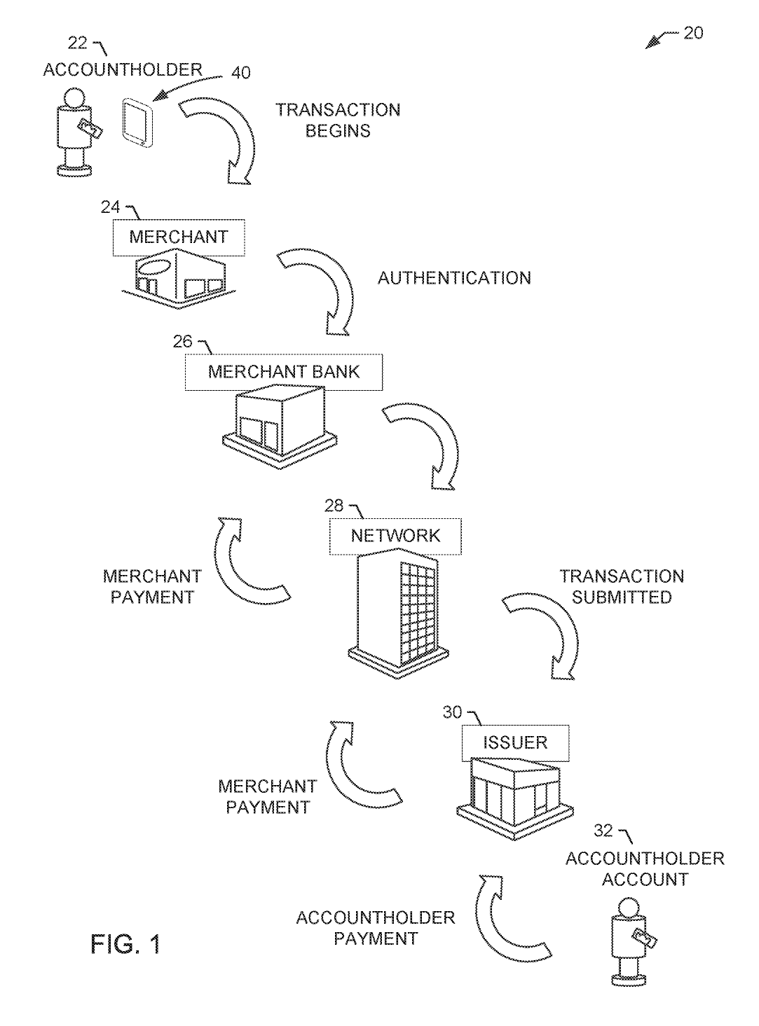

FIG. 1 is a schematic diagram illustrating an example multi-party transaction card industry system 20 for authorizing payment card transactions in which parties provide processing services to various financial entities. Embodiments described herein may relate to a transaction card system, such as a payment card payment system using the MasterCard® interchange network. The MasterCard® interchange network is a set of proprietary communications standards promulgated by MasterCard International Incorporated for the exchange of financial transaction data and the settlement of funds between financial institutions that are associated with MasterCard International Incorporated. (MasterCard is a registered trademark of MasterCard International Incorporated located in Purchase, New York).

In a typical transaction card system, a financial institution referred to as the “issuer” issues a transaction card, such as a credit card, debit card, and the like, to the consumer or account holder 22, who uses the transaction card to tender payment for a purchase from merchant 24. To accept payment with the transaction card, merchant 24 normally establishes an account with a financial institution that is part of the financial payment system. This financial institution is referred to as the “merchant bank,” the “acquiring bank,” or the “acquirer.” In one embodiment, account holder 22, also referred to as cardholder, tenders payment for a purchase using a transaction card at a transaction processing device 40 (e.g., a point of sale device), and merchant 24 then requests authorization from a merchant bank 26 for the amount of the purchase. The request is usually performed through the use of a point-of-sale terminal, which reads account information from a magnetic stripe, a chip, embossed characters, and the like, included on the transaction card of the account holder 22 and communicates electronically with the transaction processing computers of merchant bank 26. Alternatively, merchant bank 26 may authorize a third party to perform transaction processing on its behalf. In this case, the point-of-sale terminal may be configured to communicate with the third party. Such a third party may be referred to as a “merchant processor,” an “acquiring processor,” or a “third party processor.”

Using an interchange network 28, computers of merchant bank 26 or merchant processor may communicate with computers of an issuer bank 30 to determine whether account 32 of account holder 22 is in good standing and whether the purchase is covered by an available credit line of the account 32 corresponding to account holder 22. Based on these determinations, the request for authorization may be declined or accepted. If the request is accepted, an authorization code may be issued to merchant 24.

When a request for authorization is accepted, the available credit line of the account holder 22 is decreased, that is, account 32 is decreased. A charge for a payment card transaction may not be posted immediately to account 32 of the account holder 22 because payment networks, such as MasterCard International Incorporated, may have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If account holder 22 cancels a transaction before it is captured, a “void” is generated. If account holder 22 returns goods after capture of the transaction, a “chargeback” is generated. Interchange network 28 and/or issuer bank 30 stores the transaction card information, such as a type of merchant, amount of purchase, date of purchase, in a database.

After a purchase has been made, a clearing process occurs to transfer additional transaction data related to the purchase among the parties to the transaction, such as merchant bank 26, interchange network 28, and issuer bank 30. According to various aspects herein, during the clearing process, additional data (i.e., addendum data), may be added to the transaction data. Accordingly, addendum data may be associated with a transaction and transmitted between parties to the transaction as transaction data, and may be stored by any of the parties to the transaction.

After a transaction is authorized and cleared, the transaction may be settled among merchant 24, merchant bank 26, and issuer bank 30. Settlement refers to the transfer of financial data or funds among merchant 24's account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described above, the various parties to the payment card transaction include one or more of the parties shown in FIG. 1, such as, for example, account holder 22, merchant 24, merchant bank 26, interchange network 28 (also referred to as payment processor), and issuer bank 30. In the additional examples herein, a traveler, traveling cardholder, etc., may also correspond to the account holder 22 illustrated in FIG. 1.

Example of a Travel Analyzing System

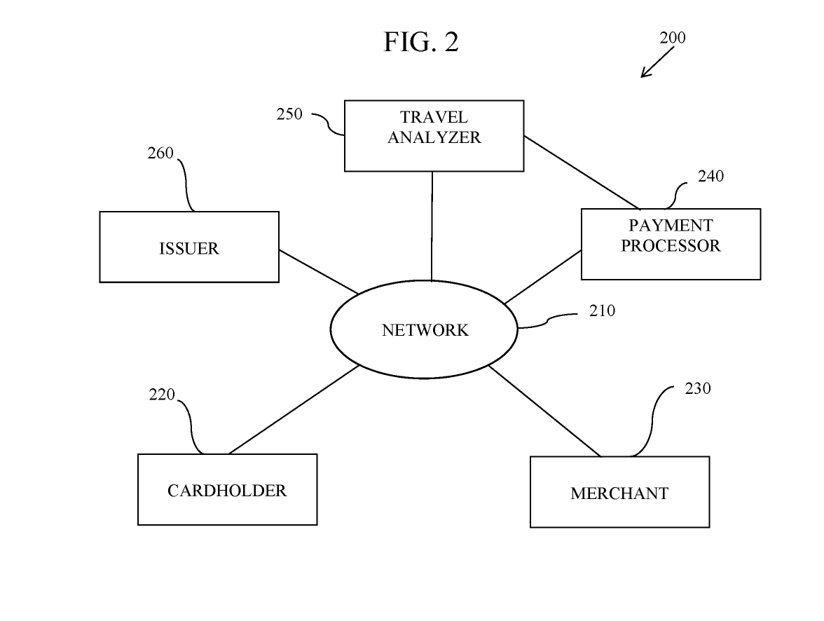

FIG. 2 is a diagram illustrating a travel analyzing system including a cardholder, a merchant, a payment processor, an issuer, and a travel analyzing computing device, which may correspond to a travel analyzing computing device, in accordance with an example embodiment of the present disclosure.

Referring to FIG. 2, travel analyzing system 200 includes computing devices that respectively represent a cardholder 220, a merchant 230, a payment processor 240, a travel analyzer 250, and an issuing bank (“issuer”) 260 which are connected to each other via network 210. Network 210 may include the Internet and/or one or more other networks. For example, a connection between the computing devices may include a wireless network, a wired network, a telephone network, a cable network, a combination thereof, and the like. Examples of a wireless network include networks such as WiFi, WiMAX, WiBro, LAN, PAN, MAN, cellular, Bluetooth, and the like.

Cardholder 220 may be a computing device, for example, a mobile phone, a smart phone, a telephone, a computer, a laptop, a desktop, a tablet, an MP3 player, a digital assistant, a server, and the like. Cardholder 220 may access a website that corresponds to the merchant 230 or that is hosted by merchant 230, may contact a phone number of merchant 230, and the like. For example, using cardholder computing device 220, a cardholder may access a travel site and make a purchase from merchant 230. As an example, merchant 230 may be a travel-based merchant such as an airline, a hotel, a rental car company, and the like.

In response to cardholder 220 entering into a travel-based transaction, such as a booking transaction, with merchant 230, transaction data corresponding to the travel-based transaction may be provided to payment processor 240 for authorization. For example, the payment processor 240 may be a processing entity such as MASTERCARD®, VISA®, AMERICAN EXPRESS®, and the like. Issuer 260 may be a third-party bank that issued a payment card to cardholder 220. For example, issuer 260 may correspond to payment processor 240. When cardholder 220 attempts to authorize a transaction using an account associated with a payment card issued by issuer 260, merchant 230 may transmit the transaction data to payment processor 240 to determine whether cardholder 220 has a sufficient amount of money in their account to cover the cost of the transaction. In response, payment processor 240 may verify with issuer 260 that cardholder 220 has sufficient funds.

The lifecycle of the transaction may include an authorization process, a clearing process, and a settlement process. During the authorization process, transaction data for authorizing the transaction may be transmitted between merchant 230, payment processor 240, and issuer 260. For example, the transaction data may include a name, an account number, a transaction amount, a date and/or a time of the transaction, and the like. At this point in the transaction, the transaction data included in the authorization process may be only that data which is necessary to approve the transaction. Payment processor 240 may verify with the issuer 260 that cardholder 220 has sufficient funds in their account to cover a cost of the transaction.

When the transaction is approved by issuer 260, the issuer 260 may send notice of the approval to payment processor 240, which may in turn transmit the notice to merchant 230. This process typically occurs within a few seconds to a few minutes of the request to authorize the transaction. After the transaction has been authorized, the transaction may be forwarded to the payment processor 240 for settlement typically later that same day, week, and the like. The settlement process includes the money being transferred from a cardholder's bank to a merchant's bank. During settlement, prior to settlement, and/or after settlement, a clearing process occurs for the transaction. The clearing process typically includes arranging bank/credit accounts for transfer of money/securities. For example, the clearing process may include payment processor 240 validating information and approving the purchase information from the merchant 230. According to various aspects, during the clearing process, the transaction data obtained during authorization may be supplemented by addendum data by the merchant 230, the payment processor 240, and the like. The clearing process may be completed after the authorization of the transaction is completed, for example, at the end of the same business day, one day later, two days later, and the like.

According to various exemplary aspects, travel analyzer 250 may analyze travel-based transactions that occur within the travel analyzing system 200. Here, the analyzer 250 may be coupled to or included within payment processor 240, within issuer 260, merchant 230, and the like. As another example, travel analyzer 250 may be a separate device connected to one or more of the other computing devices through network 210. Travel analyzer 250 may analyze transaction data from a travel-based transaction and extract travel-based information from the transaction. For example, travel analyzer 250 may analyze transaction data to determine booking information corresponding to a reservation made by cardholder 220. Such booking information may include the reservation dates, the booking date, the booking price, and the like.

The addendum data may be added during a transaction lifecycle, for example, during the clearing process (if not included in the authorization process) and may include additional information about a transaction, one or more items purchased in the transaction, merchant information, cardholder information, and the like, which was not available during the authorization process. As another example, the addendum data may include information that was available during the authorization process but that was not processed during the authorization process. As yet another example, the addendum data may include information subsequently added to the transaction after the authorization process, and the like. Also, as described herein, transaction data may include authorization data and addendum data. In some examples, the authorization data and the addendum data may partially overlap, or not overlap at all. In some cases, the addendum data may be added, or partially added during the authorization process. As another example, the addendum data may be added after the authorization process.

By extracting and analyzing booking information included in the transaction data, the travel analyzing system may determine optimal bookings. For example, a traveler may provide the travel analyzing system with a booking inquiry including details of a desired travel arrangement. In response to the booking inquiry, the travel analyzing system may retrieve transaction data or extract booking information from prior transactions meeting the criteria of the booking inquiry. By analyzing the retrieved information, the travel analyzing system may determine an optimal booking date, i.e., a booking date on which the price for the booking inquiry is lowest.

Example of Travel Analyzing Computing Device

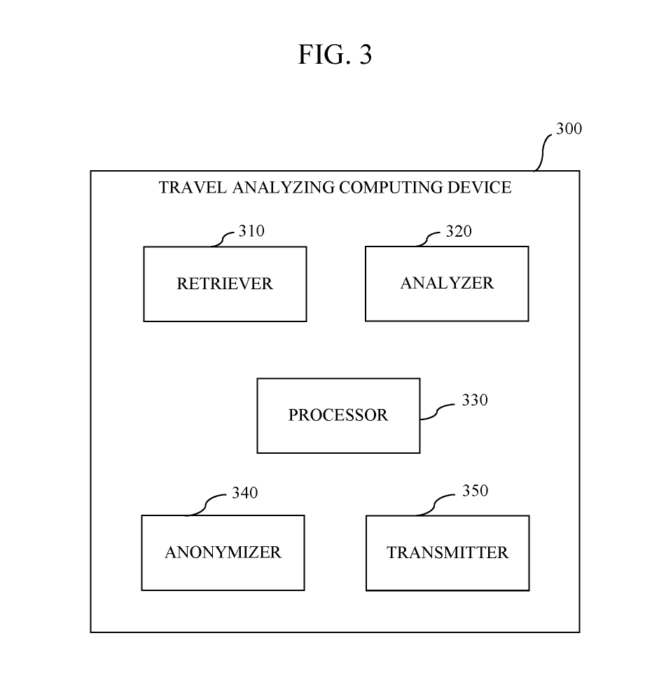

FIG. 3 is a diagram illustrating an example embodiment of a travel analyzing computing device that may be included in the travel analyzing system of FIG. 2, in accordance with an example embodiment of the present disclosure.

Referring to FIG. 3, travel analyzing computing device 300 may correspond to travel analyzer 250 shown in FIG. 2, and may be coupled to payment processor 240 or may be a separate computing device included in the system of FIG. 2, and may be connected to one or more of the other computing devices via the network 210. In this example, the travel analyzing computing device 300 includes a retriever 310, an analyzer 320, a processor 330, an anonymizer 340, and a transmitter 350. The computing device 300 may include additional components not shown, or less than the amount of components shown. Also, one or more of the components in this example may be combined or may be replaced by processor 330. The computer components described herein (e.g., retriever 310; analyzer 320; processor 330; anonymizer 340; and transmitter 350) may include hardware and/or software that are specially configured or programmed to perform the steps described herein.

Retriever 310 may obtain transaction data including addendum data corresponding to a travel-based transaction of a cardholder. For example, the retriever 310 may receive the transaction data from another device, for example, a computing device of a payment processor, a merchant, a bank, and the like, via one or more network connections, a direct connection, and the like. As another example, retriever 310 may retrieve data from a local storage (not shown) of computing device 300 or from another device. In some examples, in response to addendum data being added to a transaction, retriever 310 may automatically retrieve the addendum data, or the addendum data may be automatically transmitted to and received by retriever 310. Retriever 310 may also obtain other transaction data besides addendum data. For example, retriever 310 may obtain authorization data, settlement data, and the like, of a travel-based transaction.

To the extent the transaction data received by retriever 310 corresponds to a travel-based transaction that includes booking information, the booking information may then be extracted from the transaction data. For example, analyzer 320 may analyze the transaction data and extract booking information corresponding to a travel-based transaction made by a cardholder. For example, the transaction data may include details about an airline purchase, a hotel reservation, a car rental reservation, and the like. Accordingly, analyzer 320 may analyze the transaction data and extract booking information about the booking, for example, the reservation dates, the price of the booking, the date and/or time when the booking was made, and the like. The analyzer 320 may further analyze the transaction data and extract more specific information regarding the booking based on the particular type of booking. For example, the analyzer may extract a type of hotel or hotel room reserved by the cardholder, a type of car reserved by the cardholder, passenger information about an airline ticket purchased by the cardholder, and the like. The extracted booking information may be stored in a data storage (not shown) of computing device 300.

In certain embodiments, booking information may be extracted by applying one or more filters to the transaction data. For example, entries in the transaction data may include a merchant category code indicating that the merchant involved in the transaction is an airline, a hotel, a car rental service, and the like. As a result, the transaction data may be filtered based on one or more merchant category codes to determine which entries in the transaction data contain relevant booking information. As another example, transaction data may include a merchant identifier uniquely assigned to a particular merchant. The transaction data may then be filtered based on one or more merchant identifiers to identify transactions containing relevant booking information.

In addition to the booking information, travel information about an upcoming travel event or a current travel event of the cardholder may be extracted and/or determined. For example, analyzer 320 may analyze addendum data attached to a plane ticket, a hotel booking, a car rental reservation, and the like, and determine a travel destination of the cardholder. As a non-limiting example, the travel destination may be included in addendum data of an airline ticket, such as departure and arrival location information. As another example, the travel destination may be included in addendum data of a hotel booking, such as an address, a partial address (city, state, zip code, etc.), and the like about the hotel.

The addendum data analyzed by analyzer 320 may be added to the transaction data during a clearing process of the travel-based transaction. In this example, the addendum data may include more granular details about the transaction and items purchased in the transaction than other transaction data such as authorization data.

The transaction data or any information extracted therefrom may require anonymization to ensure cardholder privacy. Accordingly, transaction data may be anonymized in whole or in part using anonymizer 340. For example, anonymizer 340 may delete or modify portions of the transaction data to prevent disclosure of specific details of travel arrangements. In the context of rental cars, addendum data containing specific addresses corresponding to pick-up and drop-off locations of a vehicle may be replaced with more general identifiers corresponding to a broader geographic region, such as a city or commercial district.

The booking information extracted by analyzer 320 and anonymized by anonymizer 340 may then be further analyzed and processed by processor 330. Analysis and processing of the booking information by processor 330 may occur in response to travel analyzing computing device 300 receiving a booking inquiry containing details of a desired travel arrangement. The analysis and processing by processor 330 may culminate in the determination of an optimal booking date for the booking inquiry.

As an example, travel analyzing computing device 300 may receive a booking inquiry from a traveler via a website or application. In response, processor 330 may retrieve booking information from prior transactions corresponding to the details of the booking inquiry. Based on the booking information, processor 330 may then determine an optimal booking date for the travel arrangements of the booking inquiry.

Determining the optimal booking date may occur in various ways. In certain embodiments, processor 330 may conduct a statistical analysis of the retrieved booking date. For example, processor 330 may determine the daily historical mean or median price for each day between the present date (i.e., the date the booking inquiry is received) and the travel date of the booking inquiry. To the extent price information is unavailable or limited for a particular date, processor 330 may interpolate or otherwise estimate a price value. For example, processor 330 may use known daily historical prices for dates before and after the date with unknown price information in order to perform an interpolation, a regression analysis, and the like for estimating the unknown price.

In other embodiments, travel analyzing computing device 300 may include a predictive model derived from historical booking information and configured to predict the optimal booking date based on the travel date of the booking inquiry. In such embodiments, the processor 330 may be configured to extract the travel date from the booking inquiry and to operate the predictive model using the travel date such that the output of the predictive model corresponds to the optimal booking date. In addition to travel dates and historical prices, the predictive model may consider other factors and data that may influence booking prices and the optimal booking date. For example, the predictive model may account for recent price trends related to the booking. In certain examples, information and data other than transaction data may be used by the predictive model in determining an optimal booking date. Such information and data may be retrieved from external databases, Internet websites, and the like to supplement the transaction data. For example, the travel analyzing computing device 300 may include a web-crawler or have access to information and data retrieved by a web-crawler. Such information and data may include any information relevant to a destination location that may impact booking prices, including upcoming events, major news stories, weather trends, travel advisories, and the like.

In embodiments in which the travel analyzing computing device includes a predictive model, the predictive model may be periodically updated based on transaction received by travel analyzing computing device 300. For example, after booking information has been extracted from transaction data by analyzer 320 and anonymized by anonymizer 340, portions of the booking information may be used to generate a test booking inquiry. By submitting the test booking inquiry to the predictive model and comparing the results to the actual booking information, deficiencies in the predictive model may be identified and parameters of the predictive model may be modified to more accurately predict optimal booking dates.

Although processor 330 may determine an optimal booking date, processor 330 may also retrieve booking information or produce booking data from the booking information that corresponds to other sub-optimal booking dates. For example, in response to a booking inquiry, processor 330 may determine a historical or predicted price for each day between the receipt of the booking inquiry and the travel date of the booking inquiry.

In certain embodiments, data may be transmitted by transmitter 350 of travel analyzing computing device 300 to a recipient. The recipient may be a second computing device of a user of a website or application, a cardholder, one or more merchants, one or more third parties, and the like. Data transmitted by transmitter 350 may include transaction data, booking information, booking data derived from booking information, and the like. The data transmitted by transmitter 350 may also include the optimal booking date as determined by processor 330. The recipient may then further analyze or make use of the transmitted data to plan or book travel arrangements. As a non-limiting example, the travel analyzing computing device 300 may provide the optimal booking date to a travel booking mobile application or website.

In certain embodiments, travel analyzing computing device 300 may be further configured to generate an alert or reminder based on the optimal booking date determined by processor 330. For example, travel analyzing computing device 300 may store or have access to contact information of a traveler, such as an email address, a phone number, and the like. Accordingly, in response to a booking inquiry, processor 330 may determine an optimal booking date and may also generate an alarm, reminder, or similar notification. In certain embodiments, the notification may cause a user computing device to switch from a “sleep mode” to an “active display mode” and to display details regarding the booking associated with the notification. Travel analyzing computing device 300 may also be configured to receive and store a traveler's account information, such as credit card number, billing address, and the like and to automatically make a booking on the optimal booking date.

Example of User Computing Device

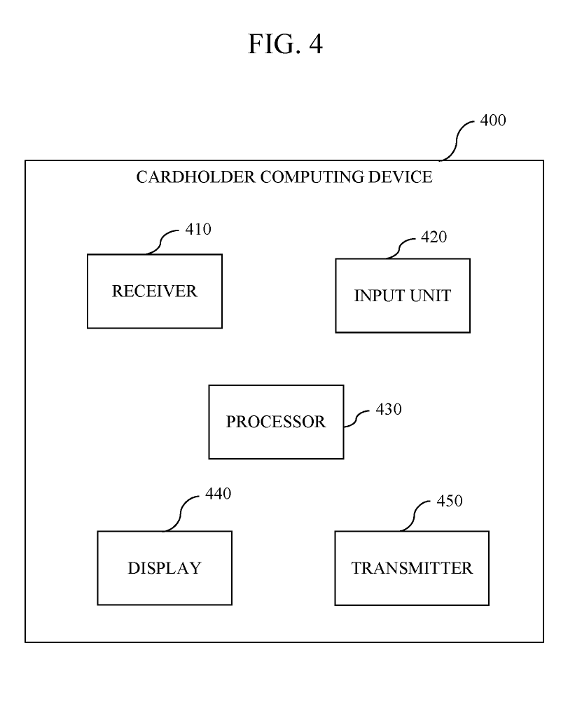

FIG. 4 is a diagram illustrating an example of a user computing device 400 that may be used to send booking inquiries to the travel analyzing system 200 of FIG. 2 and to receive from a travel analyzing system, data including optimal booking dates. More specifically, user computing device 400 may be used to communicate, directly or indirectly, with a travel analyzing computing device, such as travel analyzing computing device 300 of FIG. 3.

Referring to FIG. 4, user computing device 400 may be used by a traveler to send a booking inquiry to a travel analyzing computing device and to receive data from a travel analyzing computing device corresponding to the booking inquiry. In this example, the user computing device 400 includes a receiver 410, an input unit 420, a processor 430, a display 440, and a transmitter 450. User computing device 400 may be, for example, a laptop computer, a mobile phone, a smart phone, a tablet, a desktop computer, an MP3 player, and the like. Also, although the different features are separately illustrated, one or more of the features may be omitted, combined with other features, and the like. For example, one or more of the features may be operated by or controlled by processor 430.

User computing device 400 may be used by a traveler to communicate with travel analyzing system 200 of FIG. 2. For example, a traveler may access a mobile application or website associated with travel analyzing system 200. Through input unit 420, the traveler may provide travel details corresponding to a desired travel arrangement. Travel details may include, but are not limited to, a type of travel arrangement, travel date(s), location, a preferred price range, and the like. The travel details may be combined into a booking inquiry. Transmitter 450 may then transmit the booking inquiry to travel analyzing system 200, and more specifically to travel analyzer 250, which may be a travel analyzing computing device such as travel analyzing computing device 300 of FIG. 3. In response, travel analyzing system 200 may transmit booking data corresponding to the booking inquiry back to user computing device 400. The booking data may, in some embodiments, be received by user computing device 400 via receiver 410. Processor 430 may then process the booking data and cause the booking data to be displayed on display 440.

In addition to receiving and analyzing booking data received from travel analyzing system 200, user computing device 400 may be used to arrange and pay for bookings. For example, a traveler using user computing device 400 may be a cardholder and may have an account or payment card that is provided by an issuing bank and that corresponds to a payment processor. As described in the example of FIG. 2, a cardholder may use user computing device 400 to make a purchase from an online merchant. For example, a cardholder may purchase at least one of an airplane ticket, a hotel booking, a rental car, and the like, through a website that is displayed on display 440 of user computing device 400. A cardholder may also use user computing device 400 to make a purchase over the phone, and the like. For example, user computing device 400 may be a mobile phone and a traveler may make use user computing device 400 to make calls in to book travel arrangements.

In various examples, the merchant may receive an indication from the payment processor that indicates approval of the purchase made by the cardholder through the cardholder computing device 400. Subsequently, the transaction may go through a clearing process. During the clearing process, additional information may be added to the transaction, for example, addendum data about a travel-based transaction. The transaction data, including any associated addendum data may then be analyzed by travel analyzing system 200 or a similar system such that booking information may be extracted from the transaction data. As a result, user computing device 400 may be used to both supply booking information by facilitating travel-based transactions, and to retrieve and make use of booking data derived from booking information from previous travel-based transactions.

Input unit 420 may be used to enter inputs into user computing device 400, including inputting information corresponding to a booking inquiry, cardholder account information, and the like. Input unit may include at least one of a keyboard, a mouse, a motion recognizer, a camera, a speech recognition module, and the like. Transmitter 450 may transmit data including but not limited to, booking inquiries, purchase information, search queries, and the like. The data transmitted by transmitter 450 may be sent to a travel analyzing system, including to a travel analyzing computing device, a financial entity, a payment processor, a merchant, and the like.

Example of a Method for Optimizing Travel Bookings

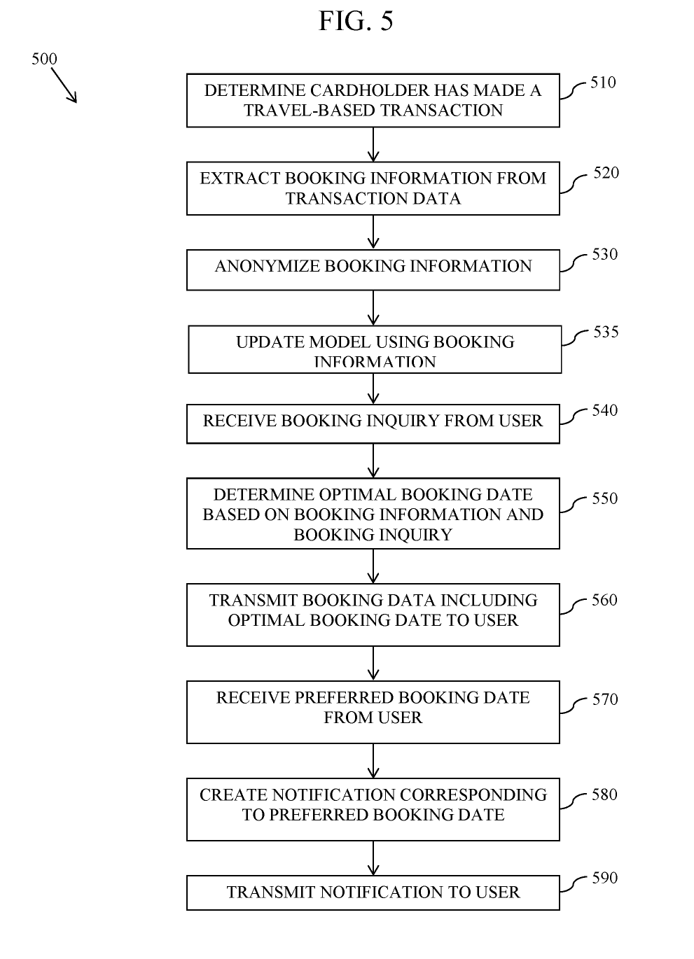

FIG. 5 is a diagram illustrating an example of a method 500 performed by travel analyzing computing device 300 when providing booking data to a user, in accordance with an example embodiment of the present disclosure.

Referring to FIG. 5, illustrated is an example of a computer-implemented method 500 for determining optimal booking dates for travel arrangements. The method 500 may be implemented by the travel analyzing computing device 300 described in the example of FIG. 3.

Method 500 includes determining 510 that a cardholder has made a travel-based transaction. As described herein, travel analyzing computing device 300 may access transaction data generated during the course of travel-based transactions. The transaction data and associated addendum data may include details of the transaction. To the extent the transaction corresponds to a travel booking (e.g., purchase of airfare, reservation of a hotel room, reservation of a rental, and the like) the transaction data may include booking information. The booking information may include, but is not limited to, travel dates, booking price, and booking date. Method 500 further includes extracting 520 the booking information from the transaction data.

In this example, method 500 also includes anonymizing the booking information 530. As previously discussed, the transaction data may include a wide range of details regarding a particular given transaction. To ensure cardholder privacy, the booking information obtained from the transaction data may be anonymized by removing and/or modifying a portion of the booking information. Anonymization may be particularly desirable or necessary in instances where the booking information is to be distributed to or used by third-parties. Anonymization of the booking information may include removing or modifying specific locations associated with a booking (e.g., pick-up and drop-off locations of a car rental), specific details of the booking (e.g., particular requests made as part of a hotel reservation), and the like. For example, specific addresses associated with a booking may be replaced with less granular indications of location such as a neighborhood, county, or city.

Method 500 further includes updating a model based on the booking information 535. As discussed herein, an optimal booking date for a given travel arrangement may be determined in whole or in part through the operation of a statistical, predictive, or other model. Accordingly, as booking information is extracted from transaction data and processed, the booking information may be used to update or refine any models underlying the determination of the optimal booking date. For example, if a statistical model that relies on average daily mean prices is used to determine an optimal booking, pricing data included in the booking information may be used to update the average mean price of the dates associated with the booking information.

After anonymizing the booking information, a booking inquiry is received 540. A booking inquiry is generally a request for information related to a desired travel arrangement. For example, a booking inquiry may correspond to a flight, a hotel room, a car rental, and the like and may include preferences, requirements, or similar criteria for the travel arrangement. These criteria may include the type of booking, travel dates, a preferred price range, and the like. A booking inquiry may also include specific information corresponding to a particular type of booking. For example, if a booking inquiry is for a plane flight, the booking inquiry may include preferences and/or requirements for fare class (e.g., first class, business class, economy), whether the flight is to be direct or indirect, a specific airline for the flight, a time of flight, and the like.

A booking inquiry may be received from a user computing device, such as user computing device 400 of FIG. 4. For example, user computing device 400 may run an application or load a website capable of receiving booking criteria from a traveler. The application or website may then generate a booking inquiry based on the booking criteria. The booking inquiry may then be sent via a transmitter to a travel analyzing computing device.

Method 500 further includes determining 550 an optimal booking date based on the booking information and booking inquiry. Determining the optimal booking date may include parsing or otherwise analyzing the booking inquiry to determine any booking criteria contained in the booking inquiry, such as the type of booking, the travel date, a preferred price range, and the like. The previously acquired booking information may then be analyzed based on the booking criteria to determine an optimal booking date. For example, in one embodiment, mean booking price or a similar statistical measure, may be calculated for one or more days between the date of the booking inquiry and the travel date. The optimal booking date may then be determined as the date having the lowest mean price. In another embodiment, an optimal booking date may be determined based on a predictive model derived from historical booking information.

Method 500 next includes transmitting 560 booking data, including the optimal booking date to source of the booking inquiry, assumed here to be a user of a user computing device, such as user computing device 400 of FIG. 4. Although the booking data includes the optimal booking date, other booking data may also be transmitted. For example, calculated or predicted prices for dates other than the optimal booking date may be transmitted. Doing so permits a user to better understand pricing trends and, as a result, make a more informed decision regarding when to book a travel arrangement. Further, additional booking pricing information may be useful if a user is precluded from making a booking on a particular date. For example, a user may know that they will be travelling or otherwise out of communication and, as a result, may not have access to an Internet-enable computer or other means for making a booking. As another example, a user may anticipate not having sufficient funds to pay for the booking as of the optimal booking date. As a result, the user may wish to select a later but more expensive date as a preferred booking date.

Method 500 next includes receiving 570 a preferred booking date from a user. A user's preferred booking date may or may not be the optimal booking date. For example, as discussed above, certain constraints may cause a user to be unavailable or lack sufficient funds to book a trip on the optimal booking date. After receiving a preferred booking date, a notification may be created 580 corresponding to the preferred booking date. A notification may generally consist of an alert or reminder to book travel arrangements on the preferred booking date. The notification may take various forms including an e-mail, a text message, a phone call, a push notification, and the like and may require the user to provide appropriate contact information. The notification may be configured to be sent on the booking date or any date in advance of the booking date. In certain embodiments, multiple notifications may be sent. For example, notifications may be created for one week in advance of the preferred booking date, one day in advance of the booking date, and the booking date itself.

Finally, method 500 may include transmitting 590 the notification to the user. As discussed above, a notification may be configured to be sent on the optimal booking date or any other date in advance of the optimal booking date. A notification may also be used to promptly alert a user to price changes to the optimal booking. In certain embodiments, the notification may cause a user computing device to switch from a “sleep mode” to an “active display mode” and to display details regarding the booking associated with the notification.

In certain embodiments, instead of or in addition to creating and transmitting notifications, bookings may be automatically made on behalf of a user. For example, when a preferred booking date is received, a transaction request may be created containing a user's account or card information, billing address, and any other information required to make a purchase on behalf of the user. When the preferred booking date arrives, the transaction request may be transmitted on behalf of the user to an appropriate merchant to facilitate the booking.

The method depicted in FIG. 5 and described above is illustrative of a method in accordance with one embodiment of this disclosure. The order of execution or performance of the operations in the embodiment illustrated in FIG. 5 and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the described embodiments. Determining a cardholder has made a travel-based transaction 510, extracting booking information from the transaction data 520, anonymizing the data 530, and updating models 535 generally correspond to collection and processing of transaction data received from a travel-based transaction. Steps 540-590, in contrast, are directed to receiving and responding to booking inquiries from a user. Accordingly, collecting and processing of transaction data may occur multiple times before or during receipt and response to a booking inquiry and, similarly, multiple booking inquiries may be received and processed between collections and processing of different pieces or batches of transaction data.

Example Application for a User Computing Device

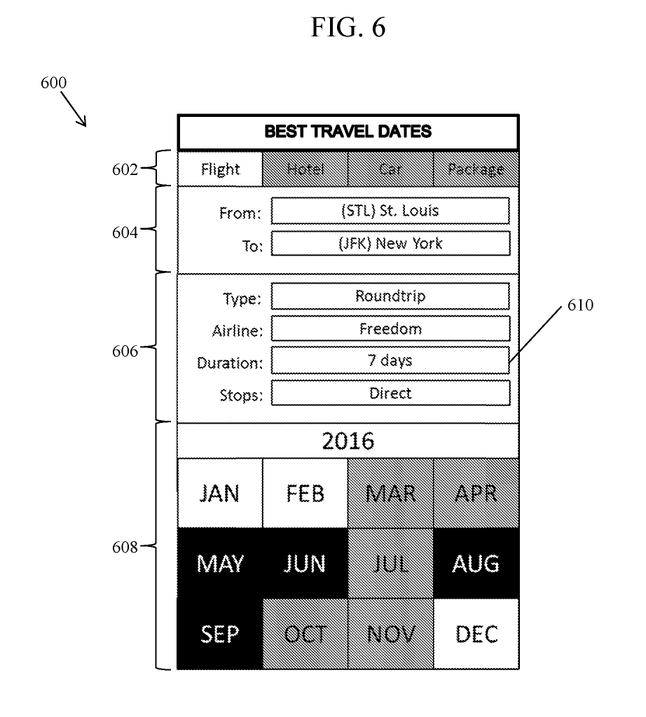

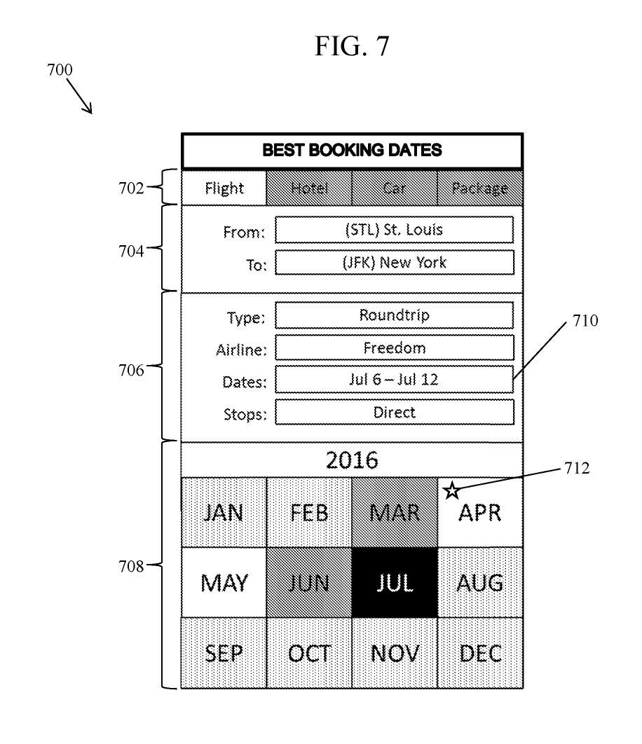

FIGS. 6 and 7 are embodiments of a user interface for providing booking criteria to and displaying booking data from a travel analyzing computing device, such as travel analyzing computing device 300 or FIG. 3. The user interface presented in FIGS. 6 and 7 may be implemented as a computer program, such as a mobile phone app, a website, a desktop application and the like. Moreover the user interface of FIGS. 6 and 7 may be run on a user computing device, such as user computing device 400 of FIG. 4, or any other suitable computing platform. The features and capabilities illustrated in the user interfaces of FIGS. 6 and 7 are merely illustrative. Additional features and capabilities of the user interface may be implemented. For example, a user interface in accordance with embodiments of the present disclosure may include features for searching and retrieving booking data, discussed in more detail below, and also features for making a reservation or purchase based on the booking data through the user interface.

As a preliminary step in determining an optimal booking date, a user must generally provide booking criteria. Booking criteria generally includes a travel date but may also include other criteria specific to the type of booking the user is inquiring about. For example, if the user is interested in purchasing an airline ticket, the user may provide details such as departure and arrival destinations, a preferred airline, preferred time of day to travel, preference for a non-stop flight, duration of travel, and the like.

Because booking prices are dictated in large part by travel dates, a user interface in accordance with this disclosure may assist a user in determining a travel date to be included in a booking inquiry. As shown in FIG. 6, for example, a user interface may permit a user to input basic flight information and receive pricing data based on travel dates.

Once all booking criteria have been established, a booking inquiry may then be submitted to a travel analyzing computing device. Using the booking criteria, the travel analyzing computing device determines booking data including an optimal booking date and transmits the booking data back to the user computing device to be displayed on the user interface.

Referring now to FIG. 6, a user interface 600 is depicted that permits a user to input travel criteria and to determine the best travel dates based on the travel criteria. As previously mentioned, user interface 600 is intended to enable a user to select a preferred travel date to be included in a subsequent booking inquiry.

User interface 600 includes several regions corresponding to different travel criteria. The booking type region 602 permits a user to select a type of booking. In FIG. 6, the booking types available include flight, hotel, car, and package, which may include a combination of two or more of a flight, hotel, or car.

User interface 600 further includes regions for inputting travel criteria corresponding to the particular type of booking selected in booking type region 602. For example, flight route region 604 allows a user to select a flight origin (St. Louis) and a flight destination (New York). Flight detail region 606 permits the user to input additional flight criteria including the type of flight (one way v. round-trip), airline, and whether the user prefers a direct flight or is willing to have a layover. Because user interface 600 is intended to assist a user in determining a preferred travel date, the user does not know the specific dates on which they will be travelling. Accordingly, flight detail region 606 includes a duration field 610 for inputting the flight duration as opposed to specific departure and return dates.

The criteria listed in flight detail region 606 are intended only as examples. In certain embodiments, some, all, or none of these details may be part of the user interface. Flight detail region 606 may also include additional criteria relevant to booking a flight. Moreover, to the extent a user wishes to make a hotel, car, or package reservation, the criteria input may vary. For example, if a user wishes to research car rental prices, the user interface may request a pick-up and drop-off location and a preferred vehicle class (e.g., SUV, sedan, economy).

After a user has input flight details into user interface 600, a travel date inquiry containing the travel criteria may be generated by the underlying application or website and sent to a travel analyzing computing device, such as travel analyzing computing device 300 of FIG. 3. In response to the travel date inquiry, the travel analyzing computing device may return travel date data corresponding to the travel date inquiry. In FIG. 6, for example, the travel date data provided by the travel analyzing computing device includes pricing information based on the travel date criteria provided in booking type region 602, flight route region 604, and flight detail region 606.

In certain embodiments, user interface 600 displays the travel date information in a calendar region 608. Calendar region 608 includes boxes corresponding to each of the twelve months of the year. Each month may be color-coded or patterned to reflect the pricing information contained in the booking data received from the travel analyzing computing device. For example, in the embodiment of FIG. 6, January, February, and December are shown as white because the prices during those periods are the lowest. March, April, July, October and November, are each shown with hatching to indicate intermediate prices. The remaining months are depicted as solid to indicate the highest range of prices. The patterns of FIG. 6 may be replaced by colors (e.g., green for low prices, orange for medium prices, and red for high prices) or any other suitable visual indicator of the relative prices associated with booking a particular reservation.

In certain embodiments, a user may be able to “drill-down” into more granular pricing data via calendar region 608. For example, by selecting a particular month, calendar region 608 may change from a monthly display to a weekly display corresponding to the selected month. A visual indicator, such as pattern or color, may then be used to provide the user with pricing information for each week. By selecting a particular week, the user may be able to obtain daily information with similar pricing information, and so on.

Based on the pricing information provided by user interface 600, the user may select a preferred travel date. The preferred travel date may subsequently be included in a booking inquiry for determining an optimal booking date.

FIG. 7 depicts a user interface 700 for determining an optimal booking date for a travel arrangement. User interface 700 may be independent from or work in conjunction with user interface 600 of FIG. 6. User interface 700 of FIG. 7 includes regions for inputting booking criteria, namely, booking type region 702, flight route region 704, and flight detail region 706.

The booking type region 702 permits a user to select a type of booking. Flight route region 704 allows a user to select a flight origin (St. Louis) and a flight destination (New York). Flight detail region 706 permits the user to input additional flight criteria including the type of flight (one way v. round-trip), airline, and whether the user prefers a direct flight or is willing to have a layover.

In contrast to the duration field 610 of user interface 600, flight detail region 706 includes a travel date field 710 for inputting specific travel dates. In certain embodiments, the travel dates indicated in travel date field 710 may be input directly by the user. In other embodiments, the travel dates included in travel date field 710 may be automatically input by a user selecting a preferred travel date via user interface 600.

Although travel dates are required for a booking inquiry, the remaining criteria in flight detail region 706 are only intended as examples. In certain embodiments, some, all, or none of these criteria may be included in user interface 700. Flight detail region 706 may also include additional criteria relevant to booking a flight. Moreover, to the extent a user wishes to make a hotel, car, or package reservation, the criteria input may vary.

After booking criteria has been input into user interface 700, a booking inquiry may be generated and sent to a travel analyzing computing device, such as travel analyzing computing device 300 of FIG. 3. In response, the travel analyzing computing device may provide booking data, including an optimal booking date corresponding to the booking criteria. User interface 700 may the display the booking data.

In certain embodiments, user interface 700 may display the booking data in a calendar region 708. Calendar region 708 includes boxes corresponding to each of the twelve months of the year. Each month may be color-coded or patterned to reflect the pricing information contained in the booking data received from the travel analyzing computing device. Similar to calendar region 608 of user interface 600, colors, patterns, or other visual indicators may be used to indicate relative pricing between the months depicted in calendar region 708. In certain embodiments user interface 700 may block out or otherwise ignore booking data for certain months. For example, in FIG. 7, a dotted fill has been applied to January, February, and August through December. The dotted fill, or another indicator such as greying out, may be used to indicate that a booking is unavailable or has otherwise been ignored by the user interface 700. For example, dates before the present date, dates after the preferred travel date, and dates that may be too early to book the reservation may be indicated as unavailable.

Similar to the process of finding a preferred travel date, a user may use the calendar region 708 to “drill down” and determine a preferred booking date for the reservation. In certain embodiments, calendar region 708 may include an optimal booking date indicator 712 to signify the optimal booking date determined by the travel analyzing computing device. The user may then use calendar region 708 to navigate to and select a preferred booking date.

In certain embodiments, user interface 700 may subsequently prompt the user to provide notification settings for configuring notifications regarding the preferred booking date. For example, user interface 700 may prompt a user for a method of notification (e.g., e-mail, text message), how far in advance a notification should be sent, and the like.

Alternatively or in addition to prompting the user for notification settings, user interface 700 may also prompt the user to input payment information to facilitate automatic booking on the preferred booking date. Such payment information may include an account or payment card number, a billing address, and the like.

As described herein, a cardholder does not necessarily require a card or an account with a card. For example, the cardholder may also be referred to as an account holder, a customer, and the like. Accordingly, a cardholder may simply have an account number without a card. Also, the cardholder may be required to input additional information, such as security credentials when using their card. As an example, and as is known to those skilled in the art, when a cardholder uses their account through a network, such as the Internet, a site at which they make a purchase may require additional details such as a PIN number, a social security number, an address, phone number, e-mail account, a CCV number, and the like, in order to authenticate or otherwise verify the account corresponds to the person making the purchase.

As will be appreciated based upon the foregoing specification, the above-described examples of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed examples of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

### Additional Considerations

The computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “card,” “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include, but is not limited to, purchases, management activities (e.g., balance checking), bill payments, achievement of targets (meeting account balance goals, paying bills on time), and/or product registrations (e.g., mobile application downloads).

For example, one or more computer-readable storage media may include computer-executable instructions embodied thereon for recommending merchants at a travel destination to a cardholder. In this example, the computing device may include a memory device and a processor in communication with the memory device, and when executed by said processor, the computer-executable instructions may cause the processor to perform a method, such as the method described and illustrated in the example of FIG. 5.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example, the system is executed on a single computer system, without a connection to a server computer. In a further example, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. §112(f) unless traditional means-plus-function language is expressly recited, such as “means for” or “step for” language being expressly recited in the claim(s).

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A travel analyzing computing device for optimizing travel bookings, the travel analyzing computing comprising one or more processors in communication with one or more memory devices, the travel analyzing computing device configured to:
retrieve historic transaction data including addendum data from travel booking transactions of cardholders;
extract, from the retrieved historic transaction data, historic booking information comprising booking dates, travel dates, and prices;
receive, from a user computing device, a booking inquiry comprising booking criteria, the booking criteria further comprising a travel date;
generate, based on at least the historic booking information and the travel date, booking data wherein the booking data comprises an optimal booking date corresponding to the booking inquiry; and
transmit the booking data to the user computing device.

2. The travel analyzing computing device of claim 1, wherein the travel analyzing computing device is further configured to:
receive, from the user computing device, a preferred booking date based on the booking data;
create a notification corresponding to the preferred booking date, the notification including a notification date; and
transmit the notification to the user computing device on the notification date.

3. The travel analyzing computing device of claim 2, wherein the notification causes the user computing device to switch from a sleep mode to an active display mode.

4. The travel analyzing computing device of claim 1, wherein the travel analyzing computing device is further configured to:
make a travel booking corresponding to the booking inquiry on one of the optimal booking date and a preferred booking date received from the user computing device.

5. The travel analyzing computing device of claim 1, wherein the addendum data is added to the historic transaction data during a clearing process of the travel booking transaction.

6. The travel analyzing computing device of claim 1, wherein the travel booking transactions of cardholders comprises airline ticket booking transactions for one or more cardholders and the addendum data comprises at least one of a flight origin, a flight destination, a flight number, a flight time, a class of passenger seating on the flight, a ticket type, and a non-stop indicator for at least one of the airline booking transactions, and wherein the price associated with the travel booking is a purchase price of the airline ticket.

7. The travel analyzing computing device of claim 1, wherein the travel booking transactions of cardholders comprises rental car booking transactions for one or more cardholders and the addendum data comprises at least one of a pickup location, a drop-off location, a rental car agency, a miles driven record, an insurance type, a corporate flag, a tax exemption flag, and a rental class for at least one of the rental car booking transactions, and wherein the price associated with the travel booking is a rental rate of the rental car.

8. The travel analyzing computing device of claim 1, wherein the travel booking transactions of cardholders comprises hotel booking transactions for one or more cardholders and the addendum data comprises at least one of a hotel brand, a hotel location, a room type, and a hotel star-level of at least one of the hotel booking transactions, and wherein the price associated with the travel-based transaction is a hotel room rate.

9. The travel analyzing computing device of claim 1, wherein the booking data is generated based on at least one of a statistical analysis and a predictive model.

10. The travel analyzing computing device of claim 1, wherein the travel analyzing computing device of claim 1 is further configured to anonymize at least a portion of the historic transaction data.

11. A computer-implemented method for optimizing travel bookings, the method being implemented by a travel analyzing computing device, the method comprising:
retrieving historic transaction data including addendum data from travel booking transactions of cardholders;
extracting, from the retrieved historic transaction data, historic booking information comprising booking dates, travel dates, and prices;
receiving, from a user computing device, a booking inquiry comprising booking criteria, the booking criteria further comprising a travel date;
generating, based on at least the historic booking information and the travel date, booking data wherein the booking data comprises an optimal booking date corresponding to the booking inquiry; and
transmitting the booking data to the user computing device.

12. The method of claim 11, further comprising:
receiving, from the user computing device, a preferred booking date based on the booking data;
creating a notification corresponding to the preferred booking date, the notification including a notification date; and
transmitting the notification to the user computing device on the notification date.

13. The method of claim 12, wherein the notification causes the user computing device to switch from a sleep mode to an active display mode.

14. The method of claim 11, further comprising:
making a travel booking corresponding to the booking inquiry on one of the optimal booking date and a preferred booking date received from the user computing device.

15. The method of claim 11, wherein the addendum data is added to the historic transaction data during a clearing process of the travel booking transaction.

16. The method of claim 11, wherein the travel booking transactions of cardholders comprises airline ticket booking transactions for one or more cardholders and the addendum data comprises at least one of a flight origin, a flight destination, a flight number, a flight time, a class of passenger seating on the flight, a ticket type, and a non-stop indicator for at least one of the airline booking transactions, and wherein the price associated with the travel booking is a purchase price of the airline ticket.

17. The method of claim 11, wherein the travel booking transactions of cardholders comprises rental car booking transactions for one or more cardholders and the addendum data comprises at least one of a pickup location, a drop-off location, a rental car agency, a miles driven record, an insurance type, a corporate flag, a tax exemption flag, and a rental class for at least one of the rental car booking transactions, and wherein the price associated with the travel booking is a rental rate of the rental car.

18. The method of claim 11, wherein the travel booking transactions of cardholders comprises hotel booking transactions for one or more cardholders and the addendum data comprises at least one of a hotel brand, a hotel location, a room type, and a hotel star-level of at least one of the hotel booking transactions, and wherein the price associated with the travel-based transaction is a hotel room rate.

19. The method of claim 11, wherein generating the booking data further comprises at least one of conducting a statistical analysis of the historic booking information and inputting at least a portion of the booking criteria into a predictive model.

20. A non-transitory computer-readable storage media having computer-executable instructions embodied thereon, when executed by at least one processor, the computer-executable instructions cause the at least one processor to:
retrieve historic transaction data including addendum data from travel booking transactions of cardholders;
extract, from the retrieved historic transaction data, booking information comprising booking dates, travel dates, and prices;
receive, from a user computing device, a booking inquiry comprising booking criteria, the booking criteria further comprising a travel date;
generate, based on at least the booking information and the travel date, booking data wherein the booking data comprises an optimal booking date corresponding to the booking inquiry; and
transmit the booking data to the user computing device.
